(19) United States
(12) Patent Application Publication
(10) Pub. No.: US 2010/0201503 A1
(43) Pub. Date: Aug. 12, 2010

(54) HAPTIC FEEDBACK TACTILE CONTROL DEVICE

(75) Inventors: Patrice Laurent, Annemasse (FR); Xavier Drouin, Annemasse (FR)

Correspondence Address: OSHA LIANG L.L.P., TWO HOUSTON CENTER, 909 FANNIN, SUITE 3500, HOUSTON, TX, 77010, US

(73) Assignee: DAV, Creteil (FR)

(21) Appl. No.: 12/602,581

(22) PCT Filed: May 30, 2008
(86) PCT No.: PCT/EP2008/056659

§ 371 Date: Apr. 30, 2010

(30) Foreign Application Priority Data
Jun. 1, 2007 (FR) 07/03904

(51) Int. Cl. G08B 6/00

(52) U.S. Cl. 340/407.2

(57) ABSTRACT

The invention relates to a haptic-feedback tactile control device that comprises a tactile surface (2) for detecting the touch contact of a user's control finger for example, and at least one vibrator (11) coupled to said tactile surface (2) for applying a vibration to said tactile surface as a response to a touch contact detection. The device further includes a mechanical vibration hollow guide (13) having an elongated shape and coupled to said vibrator (11) and having an end (15) mechanically connected to the tactile surface at an opening (17) formed in the tactile surface (12).

The present invention relates to a haptic feedback tactile control device, in particular for a motor vehicle.

More precisely, such a control device has an advantageous application for the controls located in the control console between the two front seats of a motor vehicle in order, for example, to control air conditioning functions, an audio system, a telephone system or a navigation system.

The invention can also be applied in a region of the vehicle called the dome or the roof which is located at the level of the usual location of the internal rear-view mirror in order, for example, to control the internal lights, a central locking system, an opening roof, the emergency lights or the ambient lights inside the vehicle.

This module can also be used for the window opening controls, positioning controls for the external rear-view mirrors, multi-function controls on the steering wheel or for controls for moving motorized seats.

In the motor vehicle field, the controls for various electrical devices are conventionally formed by switches. However, considering the growing number of electrical devices to be controlled, multifunction control devices are increasingly used because of the ergonomic advantages resulting from this. In fact, from a single control knob, for example produced in the form of a joystick, associated with a display screen, it is possible to navigate through scrolling menus in order to control, for example, the air-conditioning, the audio system, or the navigation system.

To increase ergonomic comfort, the use of a tactile sensor technology, alone or as a complement to such multifunction knobs, can be considered as an advantageous development.

In fact, tactile sensors, in particular for the motor vehicle field, have progressed significantly. A technology using pressure-sensitive resistors (also known as FSR sensors for “Force Sensing Resistors”) is increasingly predominating over other equivalent technologies, such as for example capacitive technologies or optical technologies because of its ease of use and its ruggedness.

Such sensors are for example known as “Digitizer Pads” and the following documents of the prior art are mentioned: U.S. Pat. No. 4,810,992, U.S. Pat. No. 5,008,497, FR 2683649 and EP 0 541 102.

These sensors comprise flexible semiconductor layers sandwiched between for example a conductive layer and a resistive layer. On applying pressure to the FSR key, its ohmic resistance reduces thus making it possible, by the application of a suitable electrical voltage, to measure the pressure applied and/or the location of the place where the pressure is applied.

According to a different concept of FSR technology, the tactile sensor comprises two flexible support sheets spaced from each other by elastic cross-pieces and bearing on mutually facing faces of the elements making it possible to produce an electrical contact when the sensor is compressed (see for example EP 1 429 355 and EP 1 429 356).

Other tactile sensor technologies comprise for example contact matrix sensors or sensors of the capacitive type.

In the implementation of these tactile sensors, in particular with smooth contact surfaces, it must be taken into account that these controls are often carried out without looking, whilst driving the vehicle.

In order not to distract the driver's attention away from the road, it is therefore important that the latter has feedback of his command carried out without looking. This can for example be produced by haptic feedback.

For this purpose, the tactile surface of the sensor is mechanically connected to one or more vibrators which are triggered on detection of a tactile command. Thus, the driver feels, at the tip of his control finger brushing the tactile surface, a vibration indicating that his command has been taken into account.

A difficulty with the known tactile control devices with haptic feedback is the overall dimensions of the vibrators which are generally mounted directly in contact with the tactile surface in order to provide a sufficient sensation of vibration.

In order to overcome this disadvantage, it has been proposed to arrange the vibrators at the level of the support structure of the tactile surface.

It has however been observed that the result was not always satisfactory with regard to the perception of the haptic feedback. Moreover, for certain cases, a large increase in the vibration power, and therefore an increase in the electrical power consumed by the vibrators, was necessary.

The purpose of the present invention is to propose a haptic feedback tactile control device which allows a distanced arrangement of the vibrator or vibrators whilst maintaining the vibration power of the vibrators at an acceptable low level.

For this purpose, the subject of the invention is a haptic feedback tactile control device comprising a tactile surface making it possible to detect the touch, for example, of a user's control finger, and at least one vibrator coupled to the said tactile surface in order to be able to apply a vibration to the said surface as a response to a detection of a touch, characterized in that it furthermore comprises a hollow mechanical vibrations guide of elongated shape which is coupled to at least one vibrator and of which one end is mechanically connected to the tactile surface at an opening formed in the tactile surface.

Other features and advantages of the invention will emerge from the following description, given by way of example and in a non-limiting way with reference to the appended drawings in which:

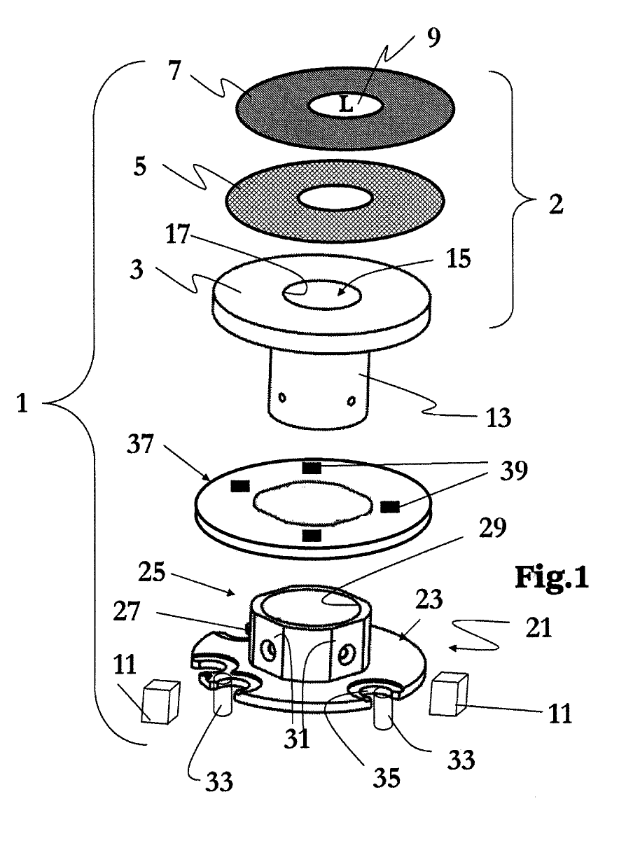

FIG. 1 is an exploded perspective view of a device according to the invention, and

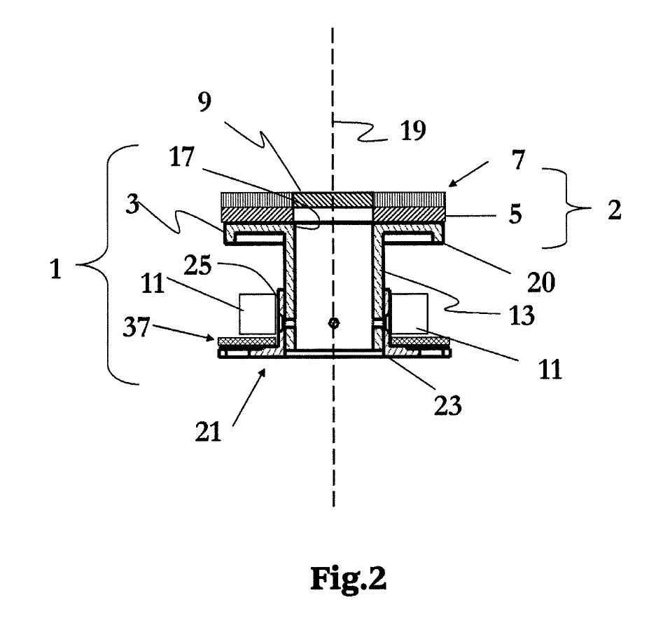

FIG. 2 is a cross-sectional view of the device of FIG. 1 in the assembled state.

The invention relates to an electrical control device and more particularly to a haptic feedback tactile control device, that is to say that the command is given by a pressure, for example, of a user's finger and that the latter feels a haptic feedback, for example a vibration, at the level of the control finger indicating that his tactile command has been taken into account. “Vibration” broadly means any forward and backward movement, in particular micro-movements with amplitudes of less than 0.2 mm.

Such a device can be used advantageously in the motor vehicle field for any control of the “surface” type, that is to say a control for which for example a finger is moved over the control surface or for which the command is given simply by pressing on a control surface.

As an example, it is possible to mention the controls for motorized seats, window-raising controls, controls for external motorized mirrors, controls at roof level such as the internal lighting controls, controls for opening an opening roof, air-conditioning controls, multifunction controls for telephony, for navigation or for the audio system, etc.

The structure and functioning of the haptic feedback tactile control device according to the invention will be described in detail with reference to FIGS. 1 and 2.

The haptic feedback tactile control device 1 comprises a tactile surface 2 having a support surface and a tactile sensor 5 disposed on this support surface 3. The tactile sensor 5 can be a capacitive, resistive or optical sensor, but preferably is a tactile sensor sensitive to pressure and more particularly an FSR sensor, for example using pressure-sensitive resistors.

This tactile surface 2 makes it possible to detect the touch, for example, of a user's control finger. The support surface 3 and the tactile sensor 5 have the shape of a washer, that is to say an annular shaped ring, thus defining a circular control track. Other shapes for the tactile surface 2 can of course be imagined, for example oval, rectangular and square (more generally polygonal) shapes.

Above the sensor 5 is placed a covering 7, for example a skin made of elastic material such as silicone or a deformable panel such as a panel made of plastic, for example of the “black panel” type (that is to say a panel which has a uniform appearance, for example black, in the absence of backlighting and which displays, for example, pictograms when there is backlighting), upon which it is possible, for example, to make control pictograms appear for the user. This covering 7 also has the shape of a washer with a central opening.

The central opening of the covering is closed using a decorative part in the form of a plug 9 bearing for example a logo “L”.

Thus, on moving a finger over the covering surface 7, the tactile sensor 5 detects the position of the control finger and even the direction of movement of the finger and/or the pushing pressure, which is transmitted by a representative signal to a processing unit (not shown). This processing unit comprises, for example, filters for processing the incoming electrical signals and a microcontroller for determining from the incoming signals the pressing position, the direction of movement, and/or the pushing pressure. Depending on the detected position, movement and/or pressure, the processing unit transmits a command to an electric and/or electronic component or device, for example for a command in a scrolling menu of an on-board computer of a motor vehicle.

Thus it is possible for example to make provision for a movement over the tactile surface 2 in the clockwise direction to increase the volume of a vehicle's car radio and a movement in the opposite direction to decrease the volume. The distinction of various pushing pressures and positions (for example light press/strong press) makes it possible, for example, to distinguish the selection of a function in a scrolling menu of an on-board computer and validation of the function thus selected.

There is thus obtained, by a tactile sensor, a control of the “scroll wheel” type, if necessary with a function of validation of a function.

In order to allow a user to be aware of the commands he applies at the level of the device 1 without looking, this device is equipped with at least one, or even several vibrators (there are two vibrators in the present case).

In order to convey the mechanical vibrations of the vibrators 11 to the control surface upon which the user moves his finger, the device comprises a hollow mechanical vibrations guide 13 of elongated shape which is coupled to at least one vibrator 11 (directly or indirectly) and of which one end 15 of the guide 13 is connected mechanically to the support surface 3 at the level of an opening 17, preferably central, formed in the support surface 3.

Thus, the vibrators can be arranged distanced from the tactile surface 2 whilst providing effective haptic feedback at the level of the tactile surface 2 with a restrained or even low vibration power.

Preferably, the guide 13 and the support surface 3 are produced as a single part, for example made of plastic.

In the figures, the guide has a generally tubular shape with a circular cross-section. An embodiment with an oval or even rectangular or square cross-section can also be envisaged.

In fact, if it is desired to produce a square-shaped tactile control device, it has proven useful to produce the opening 17 with a square shape as well as the tube with a square cross-section.

For an optimized transmission of the mechanical vibrations the longitudinal axis 19 (see FIG. 2) of the mechanical vibrations guide 13 is perpendicular to the support surface 3.

Advantageously, the wall thickness of the mechanical vibrations guide 13 is identical to the thickness of the support surface 3 in order that the vibrations are not substantially degraded such as for example by a change of frequency or a change of amplitude. This constant thickness provides continuity for the propagation of the vibrations, that is to say of the mechanical surface waves.

As can be seen in the figures (in particular in FIG. 2 in cross-section), the part forming on the one hand the vibrations guide 13 and on the other hand the support surface 3, is a solid of revolution. The vibrations thus travel along the wall of the guide 13 towards the top (see FIG. 2) and then extend radially along the support surface 3.

It has been observed that this arrangement is particularly advantageous because the mechanical vibrations extend and spread radially towards the outside. Thus interference which could reduce the amplitude of the vibrations is avoided. A coherent propagation of the surface waves is thus ensured, comparable with the propagation of surface waves which spread when, for example, a pebble is thrown into a pond.

As seen in the figures, the periphery of the support surface 3 terminates in an annular rim 20 having a portion perpendicular with respect to the surface 3. This rim 20 serves not only for fixing the covering 9 but it also makes it possible to reduce the reflections of the mechanical waves once they arrive from the center at the periphery of the support surface 3, thus also contributing to reducing any reduction in the amplitude of the vibrations, this time by reflected waves.

According to an embodiment which is not shown, the said at least one vibrator is fixed directly against a wall of the mechanical vibrations guide.

However, in order to be able to add more functions to this control device, it is preferable for the control device to furthermore comprise a base 21 having a fixing flange 23 surmounted by a chimney 25 whose outside surface 27 carries the said at least one vibrator 11 and whose inside surface 29 is in contact with the outside surface of the mechanical vibrations guide 13.

In order to facilitate the fixing, the outside surface 27 of the chimney 25 has one mounting flat 31 for each vibrator.

As shown in FIG. 1, the haptic feedback tactile control device comprises two vibrators 11 disposed at 90° to each other with respect to the longitudinal axis 19 of the mechanical vibrations guide 13. A disposition at 180° can also of course be envisaged. In all cases with several vibrators 11, it is necessary to take care not to generate, at the level of the guide 13, mechanical waves in phase opposition which would tend to cancel each other out, but rather to generate mechanical vibrations that are in phase in order to obtain an amplification, or even a resonance effect.

In order not to generate a noise and undesirable vibrations inside the passenger compartment, the haptic feedback tactile control device comprises elastic fixing elements 33 fitted in notches 35 of the flange 23 in order to prevent the propagation of mechanical vibrations to a support structure such as the dashboard.

The tactile control device furthermore comprises a printed circuit board 37 supported by the flange 23. This board can for example carry a unit for processing signals from the tactile sensor 5.

Provision is furthermore made, on the one hand, for producing the support surface 3 of the tactile sensor and the mechanical vibrations guide 13 from a transparent or translucent material and, on the other hand, for producing the tactile sensor 5 and the covering 7 (the latter at least partially, at the level of the pictograms) in such a way as to allow light to pass through. Moreover, the device comprises on the base 21, preferably at the level of the printed circuit 37, light sources 39 (for example light emitting diodes) allowing a backlighting of the tactile surface.

As seen in FIG. 2, the assembly of the support surface 3 of the tactile sensor 5, the mechanical vibrations guide 13 and the base 21 with its flange 23 and its chimney 25 has an H-shaped cross-sectional profile which is easy to install, for example on a dashboard, occupying little space.

1. A haptic feedback tactile control device comprising:
a tactile surface configured to detect a control finger touch of a user;
at least one vibrator coupled to the said tactile surface configured to apply a vibration to the tactile surface in response to the detection of the touch; and
a hollow mechanical vibrations guide of elongated shape coupled to the at least one vibrator, wherein one end of the vibrations guide is mechanically connected to the tactile surface at an opening formed in the tactile surface.

2. The haptic feedback tactile control device as claimed in claim 1, wherein the mechanical vibrations guide comprises a tubular shape.

3. The haptic feedback tactile control device as claimed in claim 2, wherein the tubular has one of an oval or a circular cross-section.

4. The haptic feedback tactile control device as claimed in claim 2, wherein the tubular has one of a rectangular or a square cross-section.

5. The haptic feedback tactile control device as claimed in claim 1, wherein a longitudinal axis of the mechanical vibrations guide is perpendicular to the tactile surface.

6. The haptic feedback tactile control device as claimed in claim 1, wherein the tactile surface comprises a support surface and a tactile sensor disposed on this support surface, wherein the mechanical vibrations guide and the support surface are made in one piece.

7. The haptic feedback tactile control device as claimed in claim 6, wherein a wall thickness of the mechanical vibrations guide is identical to a thickness of the support surface.

8. The haptic feedback tactile control device as claimed in claim 7, wherein a part forming the mechanical vibrations guide on a first side and the support surface on a second side, is a solid of revolution.

9. The haptic feedback tactile control device as claimed claim 1, wherein the at least one vibrator is fixed directly against a wall of the mechanical vibrations guide.

10. The haptic feedback tactile control device as claimed claim 6, further comprising a base having a fixing flange, surmounted by a chimney, wherein an outside surface of the chimney carries the at least one vibrator and an inside surface of the chimney is in contact with an outside surface of the mechanical vibrations guide.

11. The haptic feedback tactile control device as claimed in claim 10, wherein the outside surface of the chimney has one mounting flat for each of the at least one vibrator.

12. The haptic feedback tactile control device as claimed in claim 5, further comprising two vibrators disposed at one of 90° or 180° to each other with respect to the longitudinal axis of the mechanical vibrations guide.

13. The haptic feedback tactile control device as claimed in claim 10, further comprising elastic fixing elements fitted in notches of the fixing flange in order to prevent propagation of mechanical vibrations to a support structure.

14. The haptic feedback tactile control device as claimed in claim 10, further comprising a printed circuit board supported by the fixing flange.

15. The haptic feedback tactile control device as claimed in claim 14, wherein the support surface and the mechanical vibrations guide are made from a transparent or translucent material, wherein the tactile sensor is produced to allow light to pass through, and wherein the base carries light sources allowing a backlighting of the tactile surface.

16. The haptic feedback tactile control device as claimed in claim 10, wherein the assembly of the support surface of the mechanical vibrations guide and of the base with the fixing flange and the chimney has an H-shaped cross-sectional profile.
